(19) United States
(12) Patent Application Publication
(10) Pub. No.: US 2005/0263333 A1
(43) Pub. Date: Dec. 1, 2005

(54) Control apparatus of hybrid vehicle

(75) Inventor: Haruo Fujiki, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/135,434

(22) Filed: May 24, 2005

(30) Foreign Application Priority Data
Jun. 1, 2004 (JP) 2004-163284

(51) Int. Cl. B60K 6/04

(52) U.S. Cl. 180/65.2

(57) ABSTRACT

Motor output is suppressed without giving an uncomfortable feeling to a driver. When a target drive torque for driving a wheel is set, a high charge time torque which can be outputted in a high state of charge of a battery and a low charge time torque which can be outputted in a low state of charge of the battery are set based on an accelerator operation amount and a vehicle speed. Subsequently, a difference between the high charge time torque and the low charge time torque is multiplied by a charge correction coefficient corresponding to a state of charge, this calculated value is added to the low charge time torque Tl, and the target drive torque is calculated. Accordingly, the target drive torque can be lowered according to the state of charge, and overdischarge of the battery can be prevented. Further, even in the case where the target drive torque is lowered, the target drive torque can be changed according to the accelerator operation, and an excellent feeling can be given to the driver.

### CROSS REFERENCE TO RELATED APPLICATIONS

The disclosure of Japanese Application No. 2004-163284 filed on Jun. 1, 2004 including the specification, drawing and abstract is incorporated herein by reference in its entirety.

### BACKGROUND OF THE INVENTION

1. Field of the Invention

The present invention relates to a control apparatus of a hybrid vehicle in which a driving wheel is driven by using at least one of an engine and an electric motor.

2. Description of the Related Art

In recent years, a hybrid vehicle in which an engine and an electric motor are mounted as power sources has been developed. In this hybrid vehicle, the electric motor is used as the power source at the time of start and at the time of low speed, so that the driving region of the engine can be restricted within a high efficient region, and accordingly, the engine efficiency is improved and low fuel consumption can be achieved. As drive systems of such hybrid vehicles, there have been developed a series system in which only the electric motor is used to drive the driving wheel, a parallel system in which the electric motor and the engine are used to drive the driving wheel, and a series-parallel system in which the series system and the parallel system are combined.

Besides, in the hybrid vehicle, a dynamo driven by the engine, that is, a generator is mounted, and electric power generated by the generator is supplied to the electric motor to drive the driving wheel, and is charged in a high voltage battery. At the time of start when electric power generation is stopped as the engine is stopped, or at the time of acceleration when consumed electric power of the electric motor is increased, the electric power stored in the high voltage battery is supplied to the electric motor. As stated above, the motive power performance of the vehicle is kept by the electric power from the high voltage battery, and in the case where the high voltage battery falls into an overdischarge state, the motive power performance of the hybrid vehicle is remarkably impaired. Besides, the overdischarge state of the high voltage battery is not desirable also in view of battery deterioration.

Then, Japanese Patent No. 3094745 (page 5, FIG. 3, FIG. 5) discloses that a hybrid vehicle is developed in which a state of charge of a high voltage battery is detected, and in the case where the state of charge becomes lower than a predetermined lower limit level, a motor output is limited. As state above, the motor output is limited according to the state of charge, so that the consumed electric power of the electric motor is suppressed, and the overdischarge of the high voltage battery can be prevented, and accordingly, the deterioration of motive power performance is avoided, and the high voltage battery can be protected.

However, when the motor output is simply limited according to the state of charge, an uncomfortable feeling is given to a driver. For example, in the case where the motor output is limited in the depressing process of an accelerator pedal, even if the accelerator pedal is further depressed to the fully open state, the motor output is not changed to the increasing side, and there occurs a large gap between the driver's intention of accelerating and actual vehicle acceleration. Besides, when an insufficiency of the motor output is supplemented by the engine output in order to remove the uncomfortable feeling given to the driver, the driving region of the engine goes out of the high efficient region, and the fuel consumption performance deteriorates and the purifying performance of exhaust gas deteriorates.

### SUMMARY OF THE INVENTION

An object of the invention is to control a motor output without giving an uncomfortable feeling to a driver and to prevent overdischarge of a battery.

A control apparatus of a hybrid vehicle according to the invention is a control apparatus of a hybrid vehicle in which a driving wheel is driven by using at least one of an engine and an electric motor, and includes a state-of-charge detection unit to detect a state of charge of a battery, an operation amount detection unit to detect an accelerator operation amount of a driver, and a torque control unit to set a target drive torque of the driving wheel based on the state of charge and the accelerator operation amount, the torque control unit sets a high charge time torque corresponding to a high state of charge of the battery and a low charge time torque corresponding to a low state of charge of the battery, and in a case where the state of charge is higher than a predetermined value, the target drive torque is set to be close to the high charge time torque, and in a case where the state of charge is lower than the predetermined value, the target drive torque is set to be close to the low charge time torque.

In the control apparatus of the hybrid vehicle according to the invention, the torque control unit sets the high charge time torque and the low charge time torque based on a vehicle speed and the accelerator operation amount.

In the control apparatus of the hybrid vehicle according to the invention, the torque control unit sets the high charge time torque and the low charge time torque based on a vehicle speed, and corrects the high charge time torque and the low charge time torque based on the accelerator operation amount.

According to the invention, the high charge time torque corresponding to the high state of charge of the battery and the low charge time torque corresponding to the low state of charge of the battery are set, and the target drive torque is set to be close to the high charge time torque or the low charge time torque according to the state of charge. Therefore, when the state of charge rises, the target drive torque is raised and the motive power performance can be improved, and when the state of charge lowers, the target drive torque is lowered and the consumed electric power can be suppressed.

Besides, the high charge time torque and the low charge time torque are set, so that the torque characteristic of the target drive torque can be changed. By this, the high charge time torque can be set to the torque characteristic in which importance is given to the motive power performance, and the low charge time torque can be set to the torque characteristic in which importance is given to the suppression of consumed electric power, and the vehicle quality can be improved.

Further, since the target drive torque is set based on the accelerator operation amount, even in the case where the target drive torque is limited with the lowering of the state of charge, the target drive torque can be increased/decreased based on the accelerator operation amount. That is, even in the case where the target drive torque is limited, since the vehicle can be accelerated/decelerated according to the accelerator operation of the driver, the consumed electric power can be suppressed without giving an uncomfortable feeling to the driver.

### BRIEF DESCRIPTION OF THE DRAWINGS

FIG. 1 is a schematic view showing a drive unit which is controlled by a control apparatus of an embodiment of the invention.

FIG. 2 is a block diagram showing an electric system and a control system of a hybrid vehicle.

FIG. 3 is a flowchart showing a processing procedure of a running mode switching control and an electric power generation control.

FIG. 4 is a flowchart showing a processing procedure of a torque setting control.

FIG. 5 is a characteristic line diagram showing a torque map.

FIG. 6 is a characteristic line diagram showing a torque map.

FIG. 7 is a characteristic line diagram showing a coefficient map.

FIG. 8 is an explanatory view schematically showing a calculation process of a target drive torque.

FIG. 9 is a diagram showing a change in target drive torque according to an accelerator operation.

FIG. 10 is a flowchart showing a processing procedure of a drive control.

FIG. 11 is a characteristic line diagram showing a torque map.

FIG. 12 is a characteristic line diagram showing a rotation speed map.

FIG. 13 is a characteristic line diagram showing a torque map.

FIG. 14 is a characteristic line diagram showing a torque map.

FIG. 15 is a characteristic line diagram showing a torque map.

FIG. 16 is a flowchart showing a processing procedure of a torque setting control.

FIG. 17 is a characteristic line diagram showing a torque map.

FIG. 18 is a characteristic line diagram showing a coefficient map.

### DETAILED DESCRIPTION OF THE INVENTION

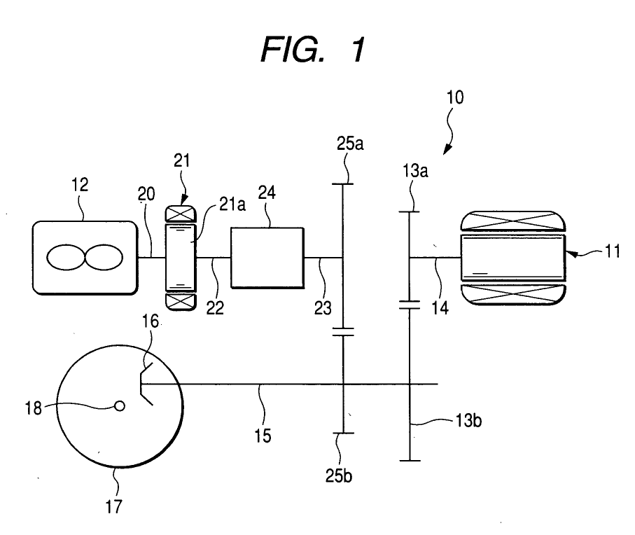

Hereinafter, embodiments of the invention will be described in detail with reference to the drawings. FIG. 1 is a schematic view showing a drive unit 10 which is controlled by a control apparatus of an embodiment of the invention. The drive unit 10 shown in FIG. 1 is the drive unit 10 applied to a front wheel drive hybrid vehicle, and includes, as power sources, a drive motor 11 as an electric motor and an engine 12 as an internal combustion engine. The drive motor 11 includes a motor output shaft 14 to which a motor side drive gear 13a is fixed, and a motor side driven gear 13b engaging with the motor side drive gear 13a is fixed to a front wheel drive shaft 15 parallel to the output shaft. Besides, a small final reduction gear 16 is fixed to a tip of the front drive shaft 15, and a not-shown differential mechanism is fitted to a large final reduction gear 17 engaging with the small final reduction gear 16. A vehicle shaft 18 extending from this differential mechanism in a vehicle width direction is coupled to front wheels as driving wheels, and motor power transmitted through the front drive shaft 15 from the drive motor 11 is transmitted to the left and right front wheels through the differential mechanism.

Besides, a dynamo, that is, a generator 21 is attached to a crank shaft 20 of the engine 12, and a rotor output shaft 22 is fixed to a rotor 21a of the generator 21. A coupling 24 actuating in an engaging state where engine power is transmitted and in an open state where the engine power is cut is provided between the rotor output shaft 22 and an engine output shaft 23 disposed coaxially thereto. An engine side drive gear 25a engaging with an engine side driven gear 25b of the front wheel drive shaft 15 is fixed to the engine output shaft 23 to which the engine power is transmitted through this coupling 24. As the coupling 24 to transmit the engine power, an engagement two-way clutch or a friction clutch is provided.

Incidentally, the generator 21 coupled to the crank shaft 20 of the engine 12 has not only a function of generating electric power by the engine power but also a function as a starter motor, and the generator 21 is driven as the starter motor so that the engine 12 can be started. Besides, the drive motor 11 has a function as a generator, and the drive motor 11 is made to operate as the generator at the time of vehicle braking, so that kinetic energy is converted into electric energy and can be recycled.

The hybrid vehicle including the drive unit 10 as stated above has the series running mode in which the driving wheel is driven by the motor power and the parallel running mode in which the driving wheel is driven by both the motor power and the engine power, and runs using the series running mode at the time of low and middle speed, and runs using the parallel running mode at the time of high speed and acceleration. Incidentally, in addition to the series running mode and the parallel running mode, an engine running mode in which the driving wheel is driven by using the engine power may be set.

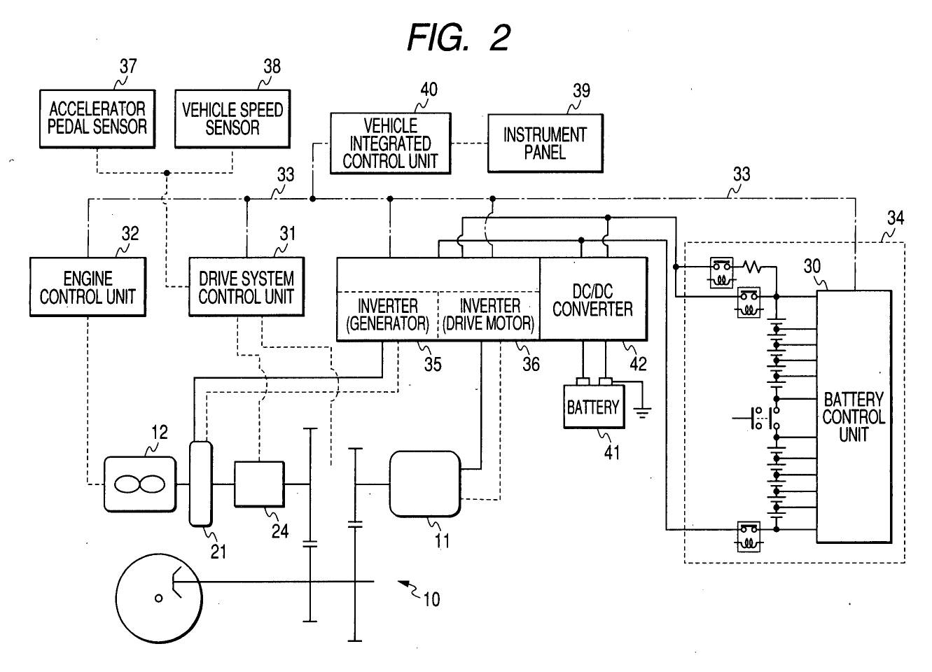

FIG. 2 is a block diagram showing an electric system and a control system of a hybrid vehicle. As shown in FIG. 2, the hybrid vehicle includes various control units 30 to 32, and the running state of the hybrid vehicle is controlled based on control signals outputted from these control units 30 to 32. The control units 30 to 32 are mutually connected through a communication cable, and a communication network 33 for mutually communicating control signals and the like among the control units is configured in the hybrid vehicle. Incidentally, a CPU to perform an arithmetical operation of the control signals is provided in each of the control units 30 to 32, and further, a ROM to store control programs, arithmetic expressions, map data and the like, and a RAM to temporarily store data are provided.

As shown in FIG. 2, a drive battery 34, which stores electric power generated by the generator 21 and is a battery to supply electric power to the drive motor 11, is mounted in the hybrid vehicle. The battery control unit 30 as a state-of-charge detection unit is provided in this drive battery 34, and the voltage, current, cell temperature and the like of the drive battery 34 are detected by the battery control unit 30. The battery control unit 30 calculates the state of charge (SOC) of the drive battery 34 based on the voltage, current and cell temperature. Incidentally, a capacitor may be mounted instead of the drive battery 34.

An inverter 35 for a generator is provided between the drive battery 34 and the generator 21, and AC current generated by the generator 21 as an AC synchronous motor is converted into DC current through the inverter 35, and then is charged in the drive battery 34. When the generator 21 is driven as the starter motor, DC current from the drive battery 34 is converted into AC current through the inverter 35, and then is supplied to the generator 21. Similarly, an inverter 36 for a drive motor is provided between the drive battery 34 and the drive motor 11, and DC current from the drive battery 34 is converted into AC current through the inverter 36, and then is supplied to the drive motor 11 as the AC synchronous motor. AC current generated by the regenerative brake, that is, AC current generated by the drive motor 11 at the braking time of the vehicle is converted into DC current through the inverter 36, and then is charged in the drive battery 34.

Besides, an accelerator operation amount Acc from an accelerator pedal sensor 37 as an operation amount detection unit and a vehicle speed V from a vehicle speed sensor 38 are inputted to the drive system control unit 31 to drive-control the drive unit 10, and further, respective drive information of the engine 12, the drive motor 11 and the generator 21, the state of charge (SOC) of the drive battery 34, current, voltage, and the like are inputted through the communication network 33. The drive system control unit 31 outputs control signals to the coupling 24, the engine control unit 32, and the inverters 35 and 36 based on the inputted various signals, and controls the drive state of the drive unit 10. Incidentally, the engine control unit 32 drive-controls a throttle valve, an injector, an igniter and the like based on the control signals from the drive system control unit 31, and controls the drive state of the engine 12.

The running state of the hybrid vehicle controlled by the respective control units 30 to 32 as stated above is displayed on a meter plate provided in a vehicle compartment, that is, an instrument panel 39, and the driver can recognize the running state. A vehicle integrated control unit 40 is connected to the foregoing communication network 33, and the drive states of the engine 12, the drive motor 11, and the generator 21, the state of charge (SOC) of the drive battery 34, and the like are outputted to the instrument panel 39 through the vehicle integrated control unit 40.

Incidentally, in the hybrid vehicle, in order to supply current to electrical components such as auxiliary machinery, an auxiliary machinery battery 41 with a voltage (for example, 12 V) lower than the drive battery 34 is mounted. In order to charge the auxiliary machinery battery 41, a DC/DC converter 42 is provided between the auxiliary machinery battery 41 and the drive battery 34, and high voltage current generated for the drive battery 34 is converted into low voltage current for the auxiliary machinery battery 41 through the DC/DC converter 42.

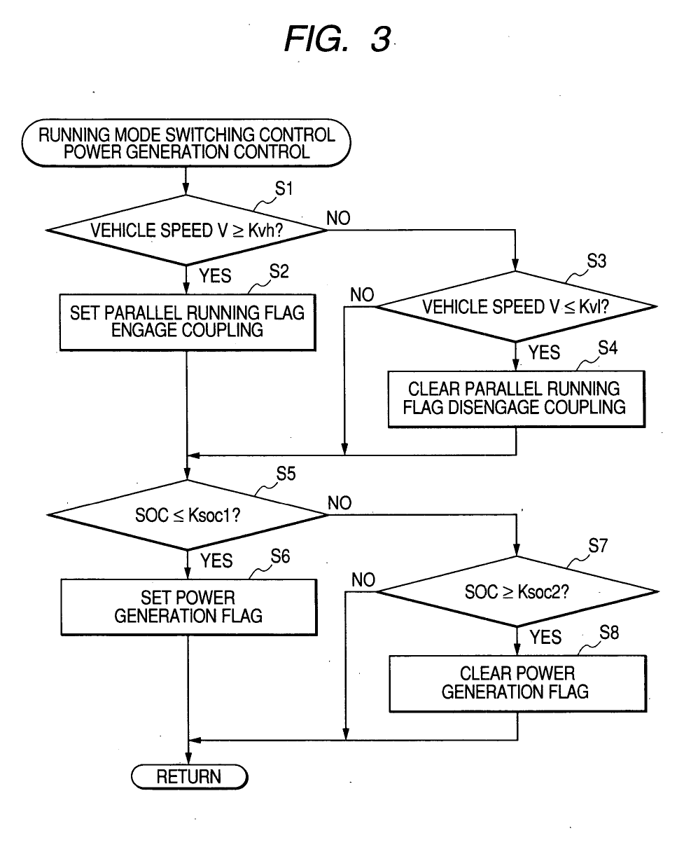

Subsequently, a description will be given to a running mode switching control and an electric power generation control executed by the drive system control unit 31. FIG. 3 is a flowchart showing a processing procedure of the running mode switching control and the electric power generation control.

As shown in FIG. 3, first, at step S1, it is judged whether or not the vehicle speed V exceeds a predetermined value Kvh. In the case where it is judged that the vehicle speed V exceeds the predetermined value Kvh, the procedure proceeds to step S2, a parallel running flag is set, and an engaging signal is outputted to the coupling 24. On the other hand, at step S1, in the case where it is judged that the vehicle speed V is lower than the predetermined value Kvh, the procedure proceeds to step S3, and it is judged whether or not the vehicle speed V is lower than a predetermined value Kv1 set to be lower than the predetermined value Kvh. At this step S3, in the case where it is judged that the vehicle speed V is lower than the predetermined value Kv1, the procedure proceeds to step S4, the parallel running flag is cleared, and an disengaging signal is outputted to the coupling 24. On the other hand, at step S3, in the case where it is judged that the vehicle speed V exceeds the predetermined value Kv1, the set state or the cleared state of the parallel running flag is maintained.

That is, when the vehicle speed V increases and exceeds the predetermined value Kvh, the coupling 24 is engaged, so that the running mode is switched to the parallel running mode. On the other hand, when the vehicle speed V decreases and becomes lower than the predetermined value Kv1, the coupling 24 is opened, and the running mode is switched to the series mode. As stated above, the running mode is switched using the two different thresholds, so that it becomes possible to suppress frequent switching of the running mode.

Subsequently, at step S5, it is judged whether or not the state of charge (SOC) is lower than a predetermined lower limit level Ksoc1. In the case where it is judged that the state of charge (SOC) is lower than the lower limit level Ksoc1, since the state is such that charging to the drive battery 34 is necessary, the procedure proceeds to step S6, and an electric power generation flag is set. On the other hand, in the case where it is judged that the state of charge (SOC) exceeds the lower limit level Ksoc1, the procedure proceeds to step S7, and a comparison is made between an upper limit level Ksoc2 set to be higher than the lower limit level Ksoc1 and the state of charge (SOC). At this step S7, in the case where it is judged that the state of charge (SOC) exceeds the upper limit level Ksoc2, since the state is such that charging to the drive battery 34 is unnecessary, the procedure proceeds to step S8, and the electric power generation flag is cleared. On the other hand, at step S7, in the case where it is judged that the state of charge (SOC) is lower than the upper limit level Ksoc2, the set state or the cleared state of the electric power generation flag is maintained.

That is, when the state of charge (SOC) decreases and becomes lower than the lower limit level Ksoc1, electric power generation is started, and on the other hand, when the state of charge (SOC) increase and exceeds the upper limit level Ksoc2, the electric power generation is stopped. The electric power generation control is performed as stated above, so that the state of charge (SOC) of the drive battery 34 is suitably kept between the upper limit level Ksoc2 and the lower limit level Ksoc1, and accordingly, the overdischarge and overcharge of the drive battery 34 can be avoided.

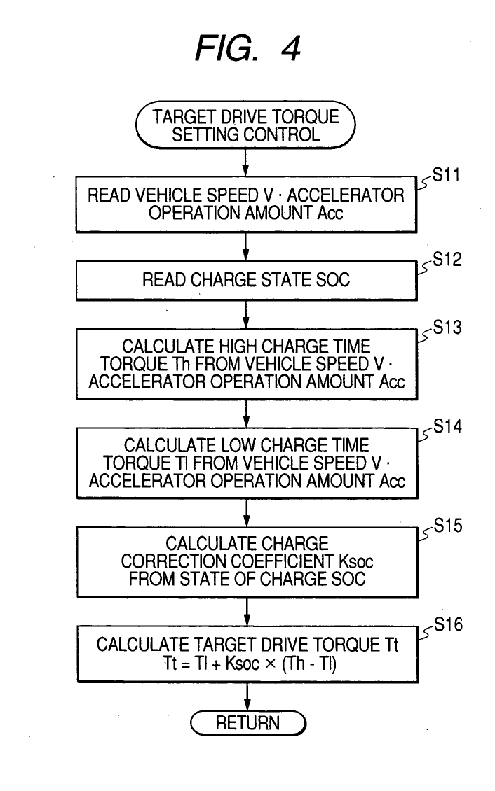

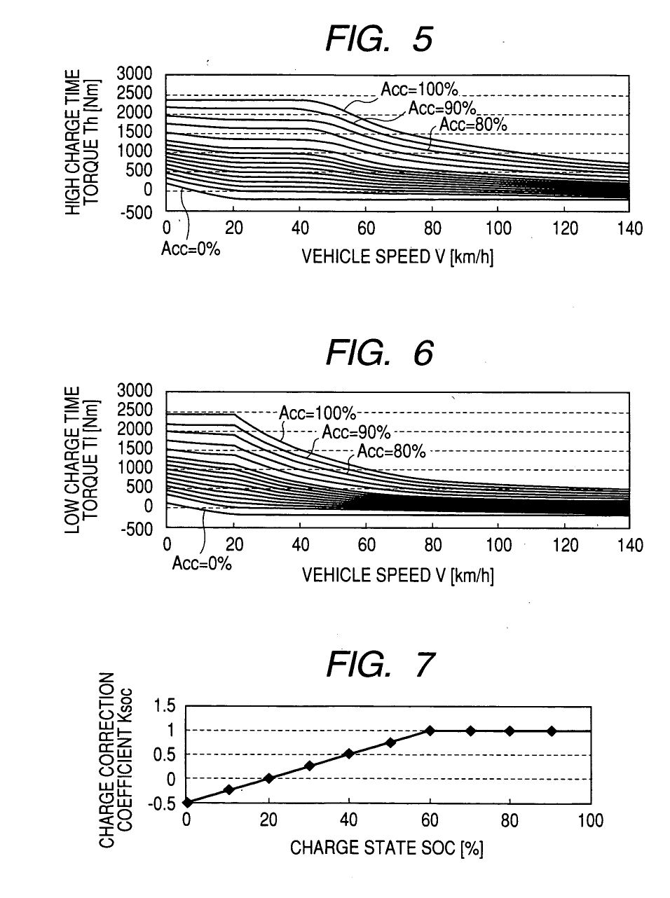

Next, a description will be given to a torque setting control which is executed by the drive system control unit 31 as a torque control unit and is for setting a target drive torque at the time of driving the driving wheel. FIG. 4 is a flowchart showing a processing procedure of the torque setting control, and FIGS. 5 to 7 are characteristic line diagrams showing various maps to which reference is made in the torque setting control.

As shown in FIG. 4, at steps S11 and S12, the accelerator operation amount Acc, the vehicle speed V, and the state of charge (SOC) are read, and at subsequent step S13, reference is made to the torque map of FIG. 5, so that a high charge time torque Th is set based on the accelerator operation amount Acc and the vehicle speed V. The high charge time torque Th is the torque which can be outputted by the drive unit 10 to the driving wheel in a high state of charge (SOC≧60%) of the drive battery 34. Subsequently, at step S14, reference is made to the torque map of FIG. 6, so that a low charge time torque Tl is set based on the accelerator operation amount Acc and the vehicle speed V. The low charge time torque Tl is the torque which can be outputted by the drive unit 10 to the driving wheel in a low state of charge (SOC=20%) of the drive battery 34, and is set to be lower than the high charge time torque Th. Incidentally, as shown in the torque maps of FIG. 5 and FIG. 6, as the accelerator operation amount Acc is increased, that is, as the accelerator pedal is depressed more, the high charge time torque Th and the low charge time torque Tl are set to be large.

At step S15, reference is made to the map of FIG. 7 based on the state of charge (SOC), so that a charge correction coefficient Ksoc corresponding to the state of charge (SOC) is set. At subsequent step S16, the high charge time torque Th, the low charge time torque Tl, and the charge correction coefficient Ksoc, which are set at the past steps, are used and a target drive torque Tt for driving the driving wheel is calculated in accordance with a following expression (1).
Tt=Tl+Ksoc×(Th−Tl) (1)

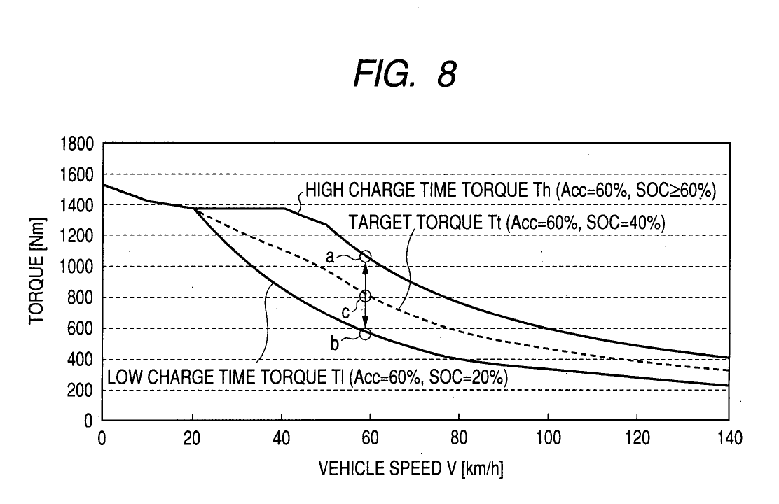

Here, FIG. 8 is an explanatory view roughly showing a calculation process of the target drive torque Tt. For example, in the case where the accelerator operation amount Acc is 60%, the vehicle speed V is 60 km/h, and the state of charge (SOC) is 40%, the target drive torque Tt is calculated as follows. As shown in FIG. 8, reference is made to the characteristic lines based on the accelerator operation amount Acc (60%) and the vehicle speed V (60 km/h), so that the high charge time torque Th (SOC≧60%, letter “a”) and the low charge time torque Tl (SOC=20%, letter “b”) are set. Incidentally, the characteristic lines of the high charge time torque Th and the low charge time torque Tl shown in FIG. 8 are selected characteristic lines corresponding to the accelerator operation amount Acc of 60% among many characteristic lines shown in FIGS. 5 and 6. Subsequently, a difference between the high charge time torque Th and the low charge time torque Tl is multiplied by the charge correction coefficient Ksoc (0.5) corresponding to the state of charge (SOC) of 40%, and this result is added to the low charge time torque Tl, so that the target drive torque Tt (letter “c”) is calculated.

That is, in the case where the accelerator operation amount is 60%, and the state of charge (SOC) is 40%, as shown in FIG. 8, the target drive torque Tt is calculated along a characteristic line of a broken line provided between the high charge time torque Th and the low charge time torque Tl. Then, as shown in FIG. 7, since the charge correction coefficient Ksoc is increased/decreased in accordance with the increase/decrease of the state of charge (SOC), in the case where the state of charge (SOC) exceeds a predetermined value of 40%, the target drive torque Tt increases to the side of the high charge time torque Th from the broken line shown in FIG. 8. On the other hand, in the case where the state of charge (SOC) is lower than 40%, the target drive torque Tt decreases to the side of the low charge time torque Tl from the broken line shown in FIG. 8. Incidentally, the predetermined value of the state of charge (SOC) is not limited to 40%, and it is needless to say that the predetermined value of the state of charge (SOC) may be changed to another value by changing the coefficient map of FIG. 7.

As stated above, since the target drive torque Tt is increased/decreased according to the state of charge (SOC), when the state of charge (SOC) increases, the target drive torque Tt is increased, and the motive power performance of the vehicle is improved. On the other hand, when the state of charge (SOC) decreases, the target drive torque Tt is reduced, and the consumed electric power of the drive motor 11 can be suppressed. By this, the overdischarge of the drive battery 34 can be avoided without impairing the motive power performance of the vehicle, and battery deterioration is prevented and the remarkable lowering of the motive power performance can be prevented. Besides, since the target drive torque Tt is gradually lowered in accordance with the lowering of the state of charge (SOC), the consumed electric power can be suppressed without giving an uncomfortable feeling to the driver.

Besides, since the high charge time torque Th corresponding to the high state of charge and the low charge time torque Tl corresponding to the low state of charge are set, the torque characteristic of the target drive torque Tt can be changed according to the state of charge (SOC). That is, when the state of charge (SOC) increases, the torque characteristic of the target drive torque Tt can be set to be close to the torque characteristic of the high charge time torque Th previously set, and when the state of charge (SOC) decreases, the torque characteristic of the target drive torque Tt can be set to be close to the torque characteristic of the low charge time torque Tl previously set.

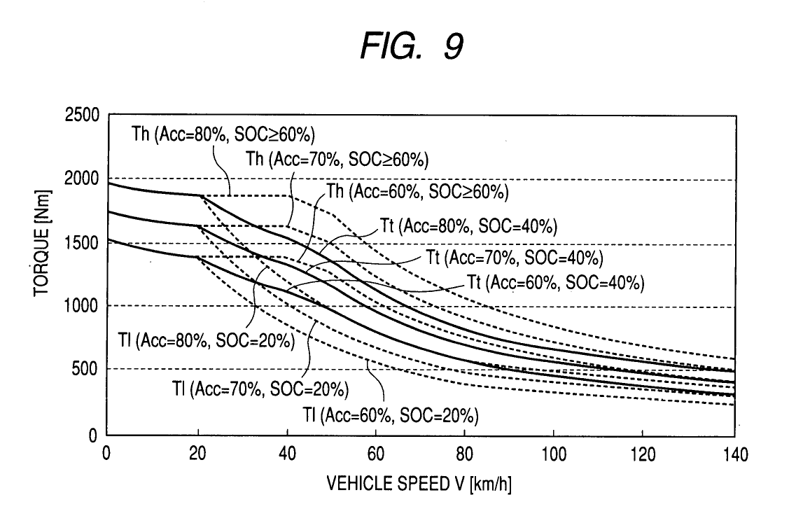

FIG. 9 is a line diagram showing the change in the target drive torque Tt according to an accelerator operation, and shows states when the accelerator operation amount Acc is changed to 60%, 70% and 80% in a state where the state of charge (SOC) is kept to be 40%. As shown in FIG. 9, since the high charge time torque Th (SOC≧60%) and the low charge time torque Tl (SOC=20%) are set to increase/decrease according to the increase/decrease of the accelerator operation amount Acc, the target drive torque Tt obtained by correcting the torque Th and Tl according to the state of charge (SOC) also increases/decreases according to the increase/decrease of the accelerator operation amount Acc. That is, even in the case where the target drive torque Tt is lowered based on the state of charge (SOC), since the vehicle can be accelerated/decelerated according to the accelerator operation of the driver, the consumed electric power can be suppressed without giving an uncomfortable feeling to the driver.

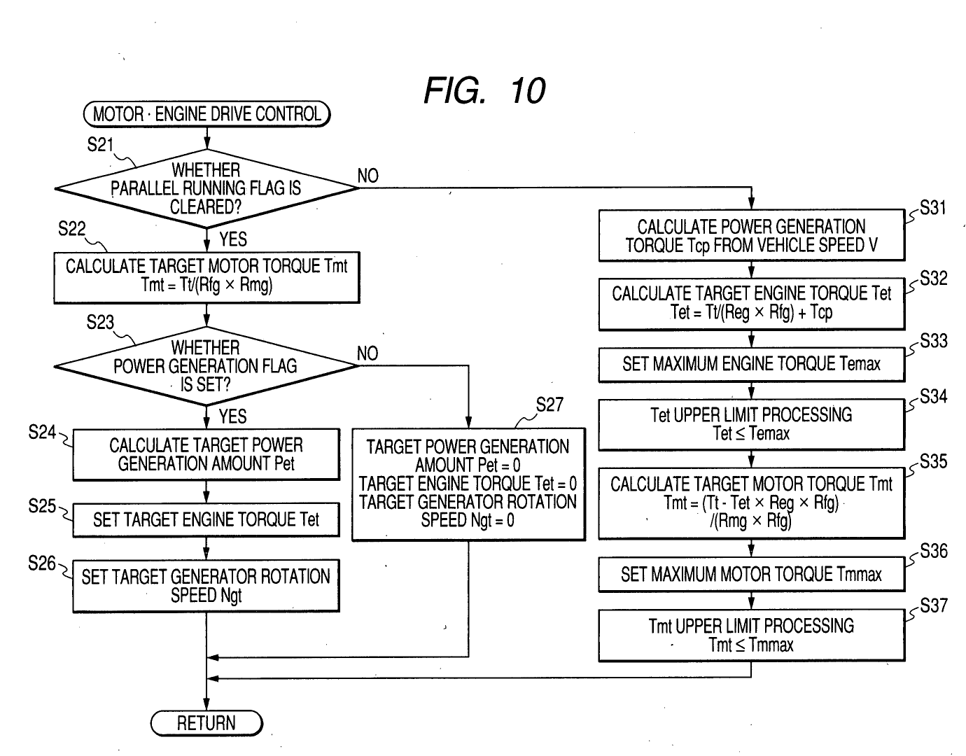

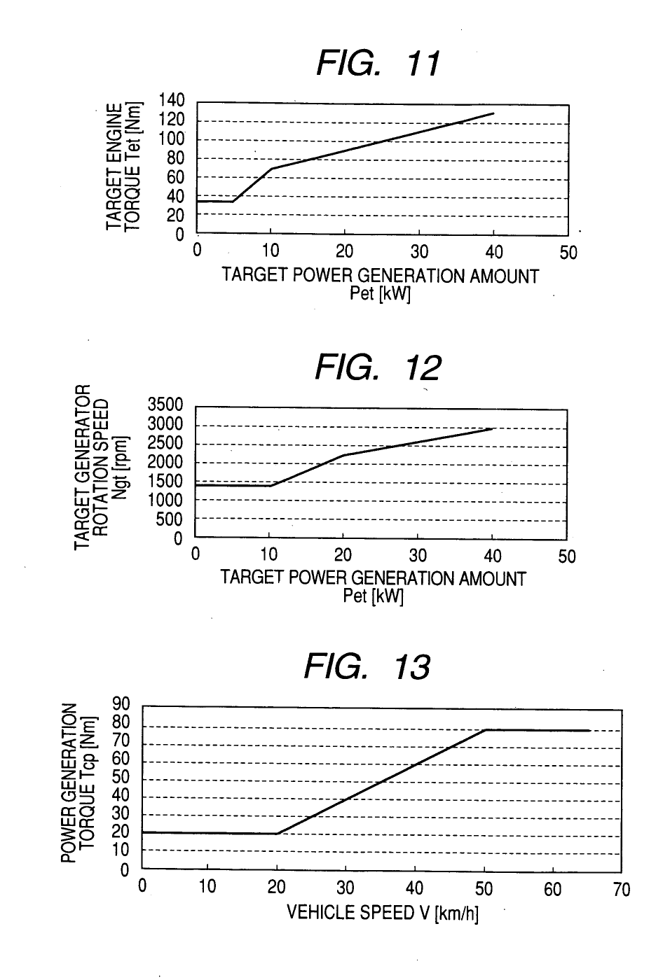

Next, a description will be given to a drive control of the drive motor 11 and the engine 12 executed by the drive system control unit 31 in order to output the thus set target drive torque Tt from the drive unit 10. FIG. 10 is a flowchart showing a processing procedure of the drive control, and FIGS. 11 to 15 are characteristic line diagrams showing various maps to which reference is made in the drive control. As shown in FIG. 10, first, at step S21, it is judged whether or not the parallel running flag has been cleared, that is, whether or not the mode is the series running mode in which the driving wheel is driven by the motor power. In the case where it is judged that the mode is the series running mode, the procedure proceeds to step S22, and a target motor torque Tmt is calculated in accordance with a following expression (2).
Tmt=Tt/(Rfg×Rmg) (2)

Here, Rfg denotes a final gear ratio set by the small final reduction gear 16 and the large final reduction gear 17, and Rmg denotes a motor gear ratio set by the motor side drive gear 13a and the motor side driven gear 13b. That is, the target motor torque Tmt calculated in accordance with the expression (2) is the motor torque necessary for obtaining the foregoing target drive torque Tt at the driving wheel. The drive system control unit 31 controls supply current to the drive motor 11 based on the target motor torque Tmt, so that the motor output is limited according to the state of charge (SOC), and the vehicle is accelerated/decelerated according to the accelerator operation.

Subsequently, at step S23, it is judged whether or not the electric power generation flag has been set. In the case where the electric power generation flag has been set, that is, in the case where the state of charge (SOC) is low, the procedure proceeds to step S24, and a target electric power generation amount Pet of the generator 21 is set. The target electric power generation amount Pet is the electric power generation amount previously set based on a test, a simulation or the like, and is the electric power generation amount obtained by driving the engine 12 in a high efficiency driving region. At step S25, reference is made to the torque map of FIG. 11 based on the target electric power generation amount Pet, so that the target engine torque Tet is set, and at subsequent step S26, reference is made to the rotation speed map of FIG. 12 based on the target generation amount Pet, so that a target generator rotation speed Ngt is set.

When the target engine torque Tet and the target generator rotation speed Ngt are set as stated above, the drive system control unit 31 controls the current of the generator 21 so that the generator rotation speed is converged to the target generator rotation speed Ngt, and the engine control unit 32 controls a throttle opening degree, a fuel injection amount and the like so that the engine torque is converged to the target engine torque Tet. The engine 12 and the generator 21 are drive-controlled as stated above, so that the electric power generation amount corresponding to the target electric power generation amount Pet is obtained. Incidentally, at step S23, in the case where the electric power generation flag has been cleared, that is, electric power generation is unnecessary, the procedure proceeds to step S27, and the target electric power generation amount Pet, the target engine torque Tet, and the target generator rotation speed Ngt are respectively set to 0.

Subsequently, a description will be given to a drive control of the drive motor 11 and the engine 12 in the parallel running mode. As shown in FIG. 10, at step S21, in the case where the parallel running flag has been set, that is, in the case where it is judged that the mode is the parallel running mode in which the driving wheel is driven by the motor power and the engine power, the procedure proceeds to step S31, and reference is made to the torque map of FIG. 13 based on the vehicle speed V, so that an electric power generation torque Tcp is set. At subsequent step S32, a target engine torque Tet is calculated in accordance with a following expression (3).
Tet=Tt/(Reg×Rfg)+Tcp (3)

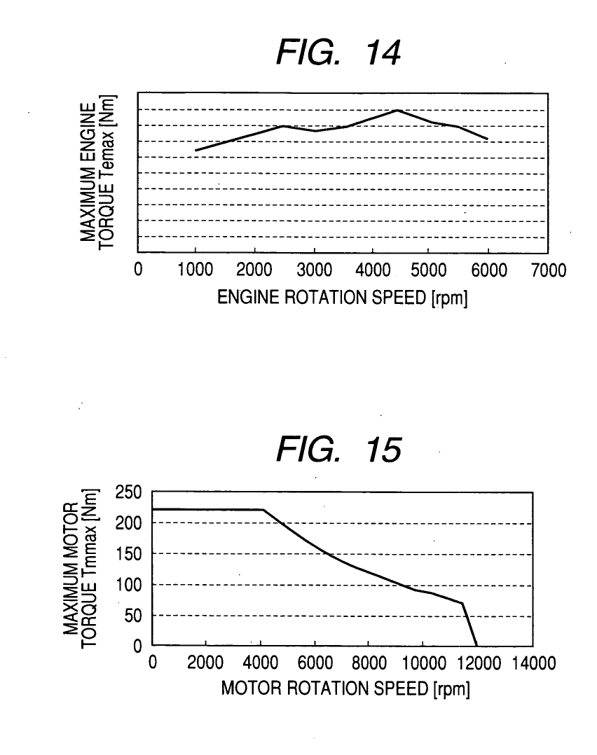

Here, Reg denotes an engine gear ratio set by the engine side drive gear 25a and the engine side driven gear 25b, and the target engine torque Tet calculated in accordance with the expression (3) is the engine torque necessary for obtaining the foregoing target torque Tt at the driving wheel while the generator 21 is driven by the electric power generation torque Tcp. However, at step S33, reference is made to the torque map of FIG. 14 based on the engine rotation speed, so that a maximum engine torque Temax is set, and at subsequent step S34, in the case where the target engine torque Tet exceeds the maximum engine torque Temax, the target engine torque Tet is lowered in order to protect the engine 12.

Subsequently, at step S35, the target motor torque Tmt is calculated in accordance with a following expression (4). The target motor torque Tmt calculated in accordance with this expression (4) is the motor torque obtained by subtracting the engine torque from the target drive torque Tt. In the case where the engine torque is insufficient and the target drive torque Tt can not be outputted, the insufficiency is supplemented by the target motor torque Tmt. However, at step S36, reference is made to the torque map of FIG. 15 based on the motor rotation speed, so that a maximum motor torque Tmmax is set, and at subsequent step S37, in the case where the target motor torque Tmt exceeds the maximum motor torque Tmmax, the target motor torque Tmt is lowered in order to protect the drive motor 11.
Tmt=(Tt−Tet×Reg×Rfg)/(Rmg×Rfg) (4)

As stated above, when the target motor torque Tmt and the target engine torque Tet are calculated based on the target drive torque Tt, the drive system control unit 31 controls supply current of the drive motor 11 based on the target motor torque Tmt, and the engine control unit 32 controls the throttle opening degree and the fuel injection amount based on the target engine torque Tet. By this, even in the parallel running mode, the motor output of the drive motor 11 is limited according to the state of charge (SOC), and the vehicle can be accelerated/decelerated according to the accelerator operation amount Acc.

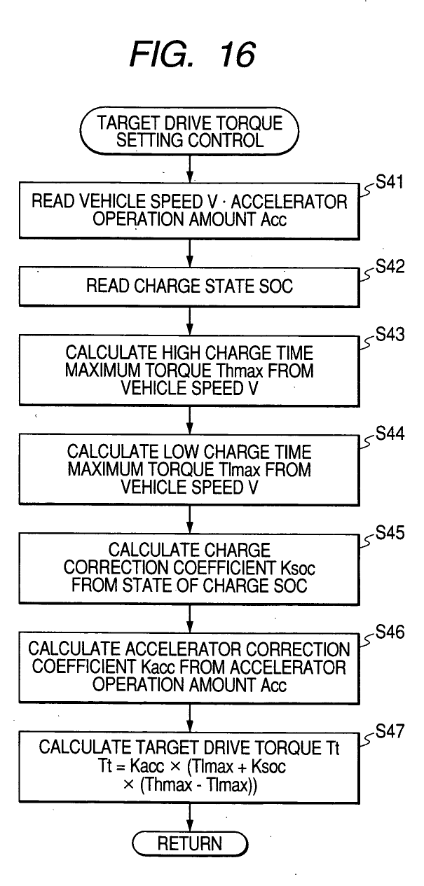

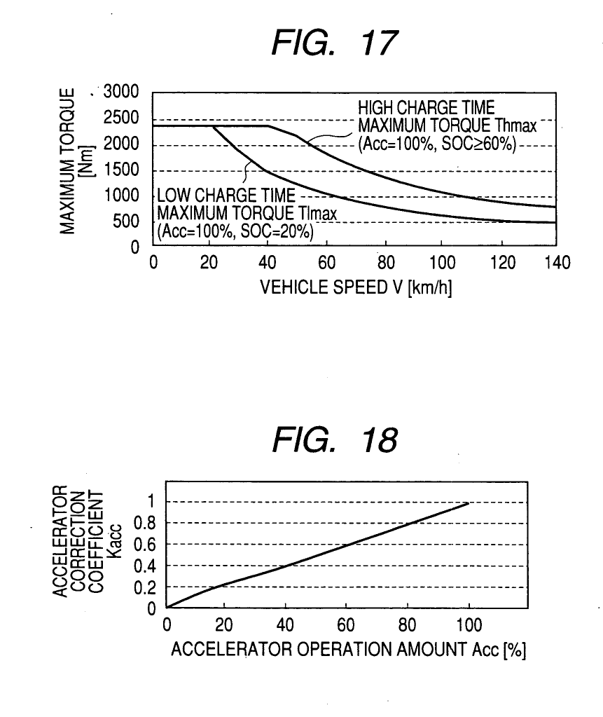

As described above, when the target drive torque Tt is set, the torque setting control is executed in accordance with the processing procedure of the flowchart shown in FIG. 4, however, the invention is not limited to this, and the target drive torque Tt may be set in accordance with another processing procedure. Here, FIG. 16 is a flowchart showing another processing procedure in the torque setting control, and FIGS. 17 and 18 are characteristic line diagrams showing various maps to which reference is made in the torque setting control.

As shown in FIG. 16, at steps S41 and S42, an accelerator operation amount Acc, a vehicle speed V, and a state of charge (SOC) are read, and subsequent steps S43 and S44, reference is made to the torque map of FIG. 17 based on the vehicle speed V, so that a high charge time maximum torque Thmax and a low charge time maximum torque Tlmax are set. Here, the high charge time maximum torque Thmax is the high charge time torque which can be outputted to the driving wheel by the drive unit 10 when the accelerator pedal is depressed to the fully open state (Acc=100%) and the drive battery 34 is in the high state of charge (SOC≧60%). The low charge time maximum torque Tlmax is the low charge time torque which can be outputted to the driving wheel by the drive unit 10 when the accelerator pedal is depressed to the fully open state (Acc=100%) and the drive battery 34 is in the low state of charge (SOC=20%). Besides, at step S45, reference is made to the coefficient map of FIG. 7 based on the state of charge (SOC), so that a charge correction coefficient Ksoc corresponding to the state of charge (SOC) is set. At subsequent step S46, reference is made to the coefficient map of FIG. 18 based on the accelerator operation amount Acc, so that an accelerator correction coefficient Kacc corresponding to the accelerator operation amount Acc is set.

At step S47, based on the high charge time maximum torque Thmax, the low charge time maximum torque Tlmax, the charge correction coefficient Ksoc, and the accelerator correction coefficient Kacc, which are set at the past steps, a target drive torque Tt for driving the driving wheel is calculated in accordance with a following expression (5). That is, the high charge time maximum torque Thmax and the low charge time maximum torque Tlmax are set based on the vehicle speed V, and the maximum torques Thmax and Tlmax are corrected based on the state of charge (SOC) and the accelerator operation amount Acc, so that the target drive torque Tt as the control target is set.
Tt=Kacc×(Tlmax+Ksoc×(Thmax−Tlmax) (5)

As stated above, also in the target drive torque Tt which is obtained by setting the high charge time torque and the low charge time torque according to the vehicle speed V and by correcting these based on the state of charge (SOC) and the accelerator operation amount Acc, since it is set based on the state of charge (SOC) and the accelerator operation amount Acc, the same effects as the foregoing effects can be obtained. Incidentally, although the high charge time torque and the low charge time torque shown in FIG. 17 are the high charge time maximum torque Thmax and the low charge time maximum torque Tlmax corresponding to the accelerator operation amount Acc of 100%, the invention is not limited to this, and a high charge time torque and a low charge time torque corresponding to another accelerator operation amount Acc may be adopted by changing the setting condition of the accelerator correction coefficient Kacc.

The invention is not limited to the above embodiment, but can be variously modified within the scope not departing from its gist. For example, although the illustrated hybrid vehicle is the front wheel drive hybrid vehicle, the invention is not limited to this, but can be applied to a rear wheel drive or four wheel drive hybrid vehicle. Besides, the invention is not limited to the series-parallel system hybrid vehicle, but may be applied to a series system or parallel system hybrid vehicle.

Besides, in the foregoing description, when the state of charge (SOC) increases and exceeds 60%, the drive battery 34 is put in the high state of charge, and when the state of charge (SOC) is lowered to 20%, the drive battery 34 is put in the low state of charge. However, the values of the state of charge (SOC) indicating the high charge state and the low charge state of the drive battery 34 are not limited to these, but can be naturally suitably changed according to the specifications of the drive motor 11, the engine 12, the generator 21, the drive battery 34 and the like.

Further, although the charge correction coefficient Ksoc and the accelerator correction coefficient Kacc are set based on the state of charge (SOC) and the accelerator operation amount Acc, the invention is not limited to the correction coefficients, and the torque correction amount may be set based on the state of charge (SOC) and the accelerator operation amount Acc.

1. A control apparatus of a hybrid vehicle in which a driving wheel is driven by using at least one of an engine and an electric motor, comprising:
a state-of-charge detection unit to detect a state of charge of a battery;
an operation amount detection unit to detect an accelerator operation amount of a driver; and
a torque control unit to set a target drive torque of the driving wheel based on the state of charge and the accelerator operation amount,
wherein the torque control unit sets a high charge time torque corresponding to a high state of charge of the battery and a low charge time torque corresponding to a low state of charge of the battery, and
in a case where the state of charge is higher than a predetermined value, the target drive torque is set to be close to the high charge time torque, and in a case where the state of charge is lower than the predetermined value, the target drive torque is set to be close to the low charge time torque.

2. A control apparatus of a hybrid vehicle according to claim 1, wherein the torque control unit sets the high charge time torque and the low charge time torque based on a vehicle speed and the accelerator operation amount.

3. A control apparatus of a hybrid vehicle according to claim 1, wherein the torque control unit sets the high charge time torque and the low charge time torque based on a vehicle speed, and corrects the high charge time torque and the low charge time torque based on the accelerator operation amount.

4. A control apparatus of a hybrid vehicle driving a wheel by using at least one of an engine and an electric motor, comprising:
a state-of-charge detection unit to detect a state of charge of a battery;
an operation amount detection unit to detect an accelerator operation amount of a driver; and
a torque control unit to set a target drive torque of the driving wheel based on the state of charge and the accelerator operation amount,
wherein the torque control unit sets a high charge time torque corresponding to a high state of charge of the battery and a low charge time torque corresponding to a low state of charge of the battery, and
in a case where the state of charge is higher than a predetermined value, the target drive torque is set by correcting the high charge time torque based on the state of charge and the accelerator operation amount, and
in a case where the state of charge is lower than the predetermined value, the target drive torque is set by correcting the lowe charge time torque based on the state of charge and the accelerator operation amount.
